(19) United States
(12) Patent Application Publication
(10) Pub. No.: US 2025/0356243 A1
(43) Pub. Date: Nov. 20, 2025

(54) SOFTWARE DEPLOYMENT PIPELINE GENERATION USING GENERATIVE ARTIFICIAL INTELLIGENCE

(71) Applicant: Dell Products L.P., Round Rock, TX (US)

(72) Inventors: Mohan Rao Gadupudi, Hyderabad (IN); Afsar Doodekula, Kurnool (IN); Praveen Raj, Karur (IN); William Cody Taylor, Round Rock, TX (US)

(21) Appl. No.: 18/663,521

(22) Filed: May 14, 2024

(51) Int. Cl. G06N 20/00

(52) U.S. Cl. CPC G06N 20/00

(57) ABSTRACT

Techniques are provided for software deployment pipeline generation using generative artificial intelligence (AI). One method comprises obtaining a trained generative AI model, trained using a plurality of continuous integration/continuous deployment (CI/CD) configuration files; obtaining information characterizing a selected software development project; and applying at least some of the information characterizing the selected software development project as one or more system prompts to the trained generative AI model, wherein the trained generative AI model predicts a portion of a software deployment pipeline associated with the selected software development project. The CI/CD configuration files used for training may be associated with an organization that is associated with the selected software development project. The predicted portion of the software deployment pipeline may comprise pipeline jobs, an automatic code completion and/or a correction of a syntax and/or a structure of at least one CI/CD configuration file being edited.

### BACKGROUND

A number of techniques exist for developing and making changes to software code. GitHub, for example, provides a software development platform that enables communication and collaboration among software developers. The software development platform provided by GitHub, for example, allows software developers to create new versions of software without disrupting a current version. Nonetheless, it is often difficult and/or time consuming for software developers to create and/or update software.

### SUMMARY

Illustrative embodiments of the disclosure provide techniques for software deployment pipeline generation using generative artificial intelligence (AI). An exemplary method comprises obtaining at least one trained generative AI model, wherein the at least one trained generative AI model is trained using a plurality of continuous integration/continuous deployment (CI/CD) configuration files; obtaining information characterizing a selected software development project; and applying at least a portion of the information characterizing the selected software development project as one or more system prompts to the at least one trained generative AI model, wherein the at least one trained generative AI model predicts at least a portion of a software deployment pipeline associated with the selected software development project.

Illustrative embodiments can provide significant advantages relative to conventional techniques. For example, problems associated with creating and/or updating software using a software development system are overcome in one or more embodiments by employing one or more generative AI models to predict at least a portion of a software deployment pipeline.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for software deployment pipeline generation using generative AI in an illustrative embodiment;

FIG. 2A shows an example of a software development lifecycle in an illustrative embodiment;

FIG. 2B shows an example of one or more pipeline jobs in various stages of a software deployment pipeline in an illustrative embodiment;

FIG. 3 illustrates a software deployment pipeline generator configured for software deployment pipeline generation using generative AI in an illustrative embodiment;

FIG. 4 illustrates the graphical user interface of FIG. 3 in further detail in an illustrative embodiment;

FIG. 5 shows an example of at least portions of the software development lifecycle of FIG. 2A in further detail in an illustrative embodiment;

FIG. 6 illustrates a generation of at least a portion of a software deployment pipeline using a generative AI model in an illustrative embodiment;

FIG. 7 is a flow diagram illustrating an exemplary implementation of a process for generating at least a portion of a software deployment pipeline using generative AI in an illustrative embodiment;

FIG. 8 illustrates a training and evaluation of a generative AI model in an illustrative embodiment;

FIG. 9 is a flow diagram illustrating an exemplary implementation of a process for training and evaluating a generative AI model, in an illustrative embodiment;

FIG. 10 illustrates a generative pre-trained transformer in an illustrative embodiment;

FIG. 11 is a flow chart illustrating a process for software deployment pipeline generation using generative AI in an illustrative embodiment;

FIG. 12 illustrates a CI/CD configuration file in an illustrative embodiment;

FIG. 13 illustrates a system prompt for a generative AI model in an illustrative embodiment;

FIG. 14 illustrates a predicted portion of a pipeline provided by a generative AI model in an illustrative embodiment;

FIG. 15 is a flow chart illustrating a process for software deployment pipeline generation using generative AI in accordance with an illustrative embodiment;

FIG. 16 illustrates an exemplary processing platform that may be used to implement at least a portion of one or more embodiments of the disclosure comprising a cloud infrastructure; and

FIG. 17 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for software deployment pipeline generation using generative AI.

The term DevOps generally refers to a set of practices that combines software development and information technology (IT) operations. DevOps are increasingly being used to shorten the software development lifecycle and to provide continuous integration, continuous delivery, and continuous deployment. Continuous integration generally allows development teams to merge and verify changes more often by automating software generation (e.g., converting source code files into standalone software components that can be executed on a computing device) and software tests, so that errors can be detected and resolved early. Continuous delivery extends continuous integration and includes efficiently and safely deploying the changes into testing and production environments. Continuous deployment allows code changes that pass an automated testing phase to be automatically released into the production environment, thus making the changes visible to end users. Such processes are typically executed within a software generation and deployment pipeline.

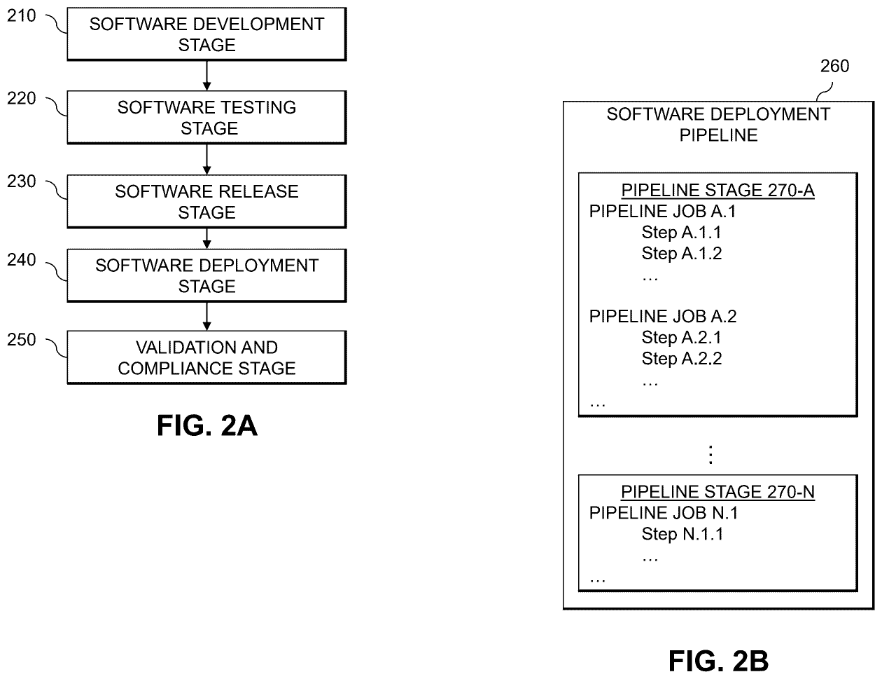

DevOps solutions typically employ blueprints that encompass continuous integration, continuous testing (CT), continuous deployment (also referred to as continuous development) and/or continuous change and management (CCM) abilities. DevOps blueprints allow development teams to efficiently innovate by automating workflows for a software development and delivery lifecycle. A typical software development lifecycle is discussed further below in conjunction with FIG. 2A.

A software deployment pipeline (sometimes referred to as a CI/CD pipeline) automates a software delivery process, and typically comprises a set of automated processes and tools that allow developers and an operations team to work together to generate and deploy application software code to a production environment. A preconfigured software deployment pipeline may comprise a specified set of elements and/or environments. Such elements and/or environments may be added or removed from the software deployment pipeline, for example, based at least in part on the software and/or compliance requirements. A software deployment pipeline typically comprises one or more quality control gates to ensure that software code does not get released to a production environment without satisfying a number of predefined testing and/or quality requirements. For example, a quality control gate may specify that software code should compile without errors and that all unit tests and functional user interface tests must pass.

One or more aspects of the disclosure recognize that a poor understanding and execution of CI/CD operations can impair the pace of a software development project. CI/CD pipelines often involve multiple stages and environments, such as development, testing and production. Each of these stages may require different tools and configurations, which are defined in a configuration file. Managing dependencies and ensuring that the pipeline is stable and reliable may also be challenging. In addition, performance bottlenecks in a CI/CD pipeline may arise from a misconfiguration. Further, existing integrated development environments (IDEs) do not provide support for CI/CD tasks. The disclosed techniques for software deployment pipeline generation using generative AI provide a development environment for CI/CD pipelines with pipeline job recommendations, automatic completion of software code, error detection and complete CI/CD configuration file generation. In at least some embodiments, the disclosed techniques for pipeline generation using generative AI are integrated with an IDE (for example, as a plugin and/or an extension).

In one or more embodiments, the disclosed techniques for software deployment pipeline generation using generative AI allow portions of a CI/CD pipeline to be predicted and improved. In at least some embodiments, the disclosed techniques for pipeline generation using generative AI provide an interactive terminal (e.g., a bash terminal on a user display that provides a command-line interface shell program) to execute one or more selected pipeline jobs and to obtain real-time results. The user can use the interactive terminal to issue job commands and obtain feedback. A user may optionally specify one or more breakpoints in a given pipeline job to pause and evaluate the execution. In this manner, the user can examine the values of variables, and step through execution of a given job script, e.g., line-by-line.

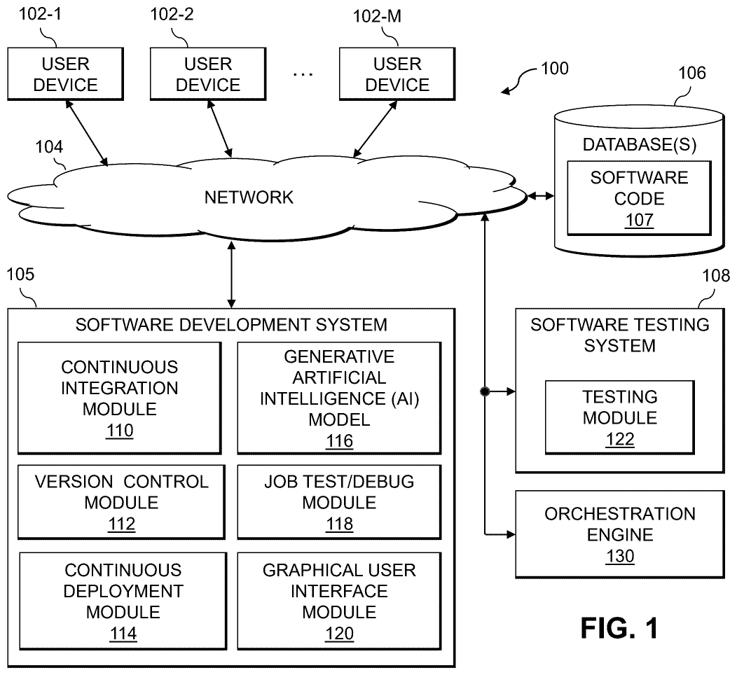

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 may be employed, for example, by software developers and other DevOps professionals to perform, for example, software development and/or software deployment tasks. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a software development system 105, a software testing system 108 and an orchestration engine 130.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The software development system 105 comprises a continuous integration module 110, a version control module 112, a continuous deployment module 114, a generative AI model 116, a job test/debug module 118 and a graphical user interface (GUI) module 120. Exemplary processes utilizing elements 110, 112, 114, 116, 118 and/or 120 will be described in more detail with reference to, for example, the flow diagrams of FIGS. 2A, 5, 6 through 9, 11 and 15.

In at least some embodiments, the continuous integration module 110, the version control module 112 and/or the continuous deployment module 114, or portions thereof, may be implemented using functionality provided, for example, by commercially available DevOps and/or CI/CD tools, such as the GitLab development platform, the GitHub development platform, the Azure DevOps server and/or the Bitbucket CI/CD tool, or another Git-based DevOps and/or CI/CD tool. The continuous integration module 110, the version control module 112 and the continuous deployment module 114 may be configured, for example, to perform CI/CD tasks and to provide access to DevOps tools and/or repositories. The continuous integration module 110 provides functionality for automating the integration of software code changes from multiple software developers or other DevOps professionals into a single software project.

In one or more embodiments, the version control module 112 manages canonical schemas (e.g., blueprints, job templates, and software scripts for jobs) and other aspects of the repository composition available from the DevOps and/or CI/CD tool. Source code management (SCM) techniques may be used to track modifications to a source code repository. In some embodiments, SCM techniques are employed to track a history of changes to a software code base and to resolve conflicts when merging updates from multiple software developers.

The continuous deployment module 114 manages the automatic release of software code changes made by one or more software developers from a software repository to a production environment, for example, after validating the stages of production have been completed. The continuous deployment module 114 may interact in some embodiments, with the software testing system 108 to coordinate the testing of software code and/or verify a successful testing of software code.

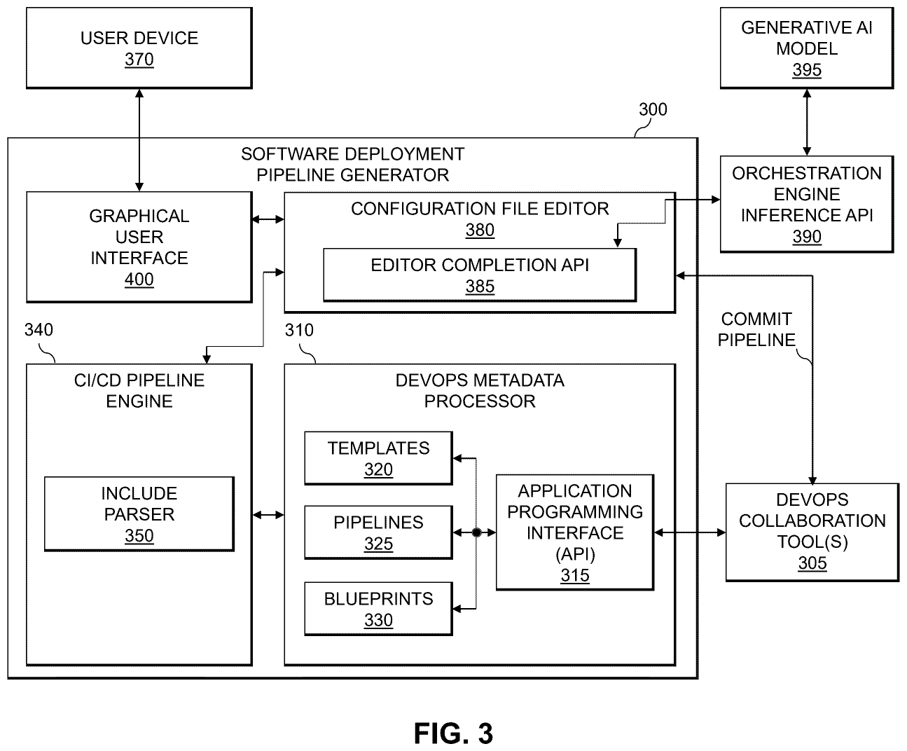

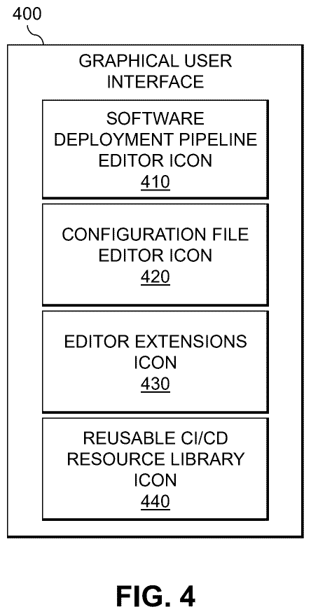

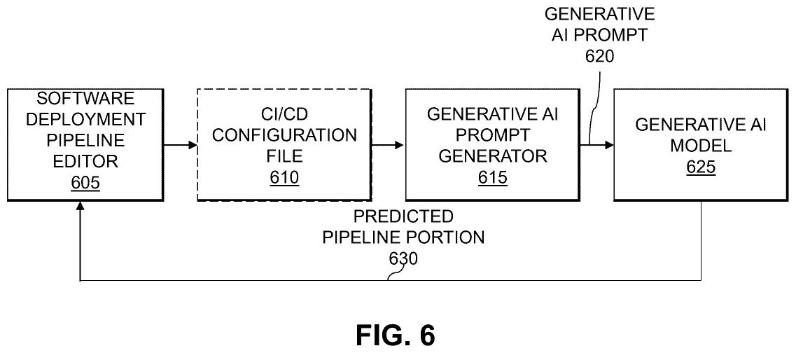

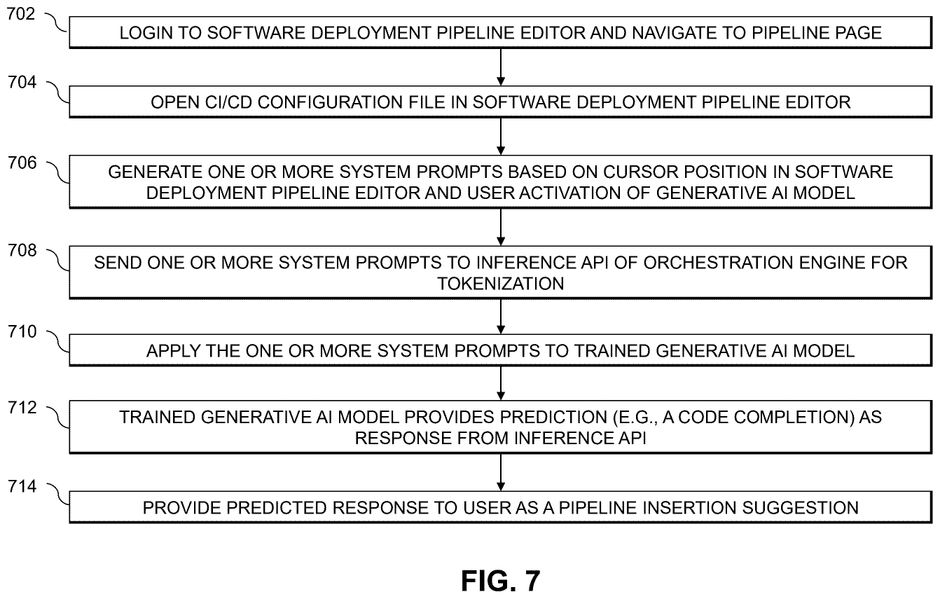

In at least some embodiments, the generative AI model 116 may predict one or more pipeline jobs or other portions of a software deployment pipeline, as discussed further below in conjunction with, for example, FIGS. 6 and 7, for example. In one or more embodiments, the job test/debug module 118 may include functionality for testing and/or debugging one or more pipeline jobs generated using the generative AI model 116, as discussed herein. The GUI module 120 may include functionality in some embodiments for the generation and interaction of, for example, a pipeline manager and a job test/debug module 118, as discussed further below in conjunction with FIGS. 3 and 4, for example.

It is to be appreciated that this particular arrangement of elements 110, 112, 114, 116, 118 and/or 120 illustrated in the software development system 105 of the FIG. 1 embodiment is presented by way of example only, and alternative arrangements can be used in other embodiments. For example, the functionality associated with the elements 110, 112, 114, 116, 118 and/or 120 in other embodiments can be combined into a single module or separated across a larger number of modules. As another example, multiple distinct processors can be used to implement different ones of the elements 110, 112, 114, 116, 118 and/or 120 or portions thereof.

At least portions of elements 110, 112, 114, 116, 118 and/or 120 may be implemented at least in part in the form of software that is stored in memory and executed by a processor.

The software testing system 108 comprises a testing module 122 that performs one or more software tests within a software deployment pipeline, as would be apparent to a person of ordinary skill in the art. Generally, software testing aims to ensure that bugs and other software code errors are detected as soon as possible and are remedied before being exposed to end-users. In some embodiments, the software testing system 108 performs pipeline-level testing, for example, in a virtualized environment.

It is to be appreciated that this particular arrangement of the testing module 122 illustrated in the software testing system 108 of the FIG. 1 embodiment is presented by way of example only, and alternative arrangements can be used in other embodiments. For example, the functionality associated with testing module 122 in other embodiments can be separated across a larger number of modules and/or multiple distinct processors can be used to implement the functionality associated with testing module 122, or portions thereof.

In at least some embodiments, the orchestration engine 130 may be implemented, at least in part, using the functionality of Kubernetes or variants thereof.

In one or more embodiments, the orchestration engine 130 may create environments using containers that provide a form of operating system virtualization. One container might be used to run a small microservice or a software process, as well as larger applications. The container provides the necessary executables, binary code, libraries, and configuration files. In some embodiments, the orchestration engine 130 may employ a PKS cluster (e.g., an enterprise Kubernetes platform) that enables developers to provision, operate and/or manage enterprise-level Kubernetes clusters to execute a pipeline job. The Docker open-source containerization platform may be leveraged in some embodiments for building, deploying, and/or managing containerized applications. Docker enables developers to package applications into container-standardized executable components that combine application source code with operating system libraries and dependencies required to run that code in any environment.

Additionally, the software development system 105 and/or the software testing system 108 can have at least one associated database 106 configured to store data pertaining to, for example, software code 107 of at least one application. For example, the at least one associated database 106 may correspond to at least one code repository that stores the software code 107. In such an example, the at least one code repository may include different snapshots or versions of the software code 107, at least some of which can correspond to different branches of the software code 107 used for different development environments (e.g., one or more testing environments, one or more staging environments, and/or one or more production environments).

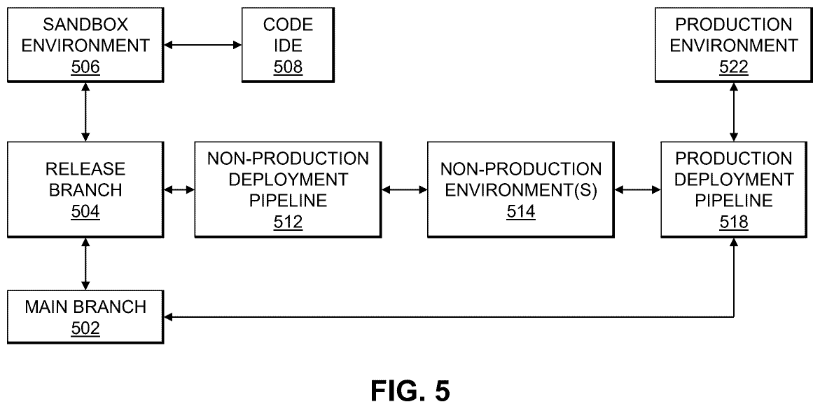

Also, at least a portion of the one or more user devices 102 can also have at least one associated database (not explicitly shown in FIG. 1). As an example, such a database can maintain a particular branch of the software code 107 that is developed in a sandbox environment associated with a given one of the user devices 102, as discussed further below in conjunction with FIG. 5. Any changes associated with that particular branch can then be sent and merged with branches of the software code 107 maintained in the at least one database 106, for example.

An example database 106, such as depicted in the present embodiment, can be implemented using one or more storage systems associated with the software development system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the software development system 105 are one or more input-output devices, which illustratively comprise keyboards, displays or other types of input-output devices in any combination. Such input-output devices can be used, for example, to support one or more user interfaces to the software development system 105, as well as to support communication between software development system 105 and other related systems and devices not explicitly shown.

Additionally, the software development system 105, the software testing system 108 and/or the orchestration engine 130 in the FIG. 1 embodiment are assumed to be implemented using at least one processing device. Each such processing device generally comprises at least one processor and an associated memory, and implements one or more functional modules for controlling certain features of the software development system 105, the software testing system 108 and/or the orchestration engine 130.

More particularly, the software development system 105, the software testing system 108 and/or the orchestration engine 130 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the software development system 105, the software testing system 108 and/or the orchestration engine 130 to communicate over the network 104 with the user devices 102, and illustratively comprises one or more conventional transceivers.

It is to be understood that the particular set of elements shown in FIG. 1 for software development system 105 and the software testing system 108 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the software development system 105, the software testing system 108 and database(s) 106 can be on and/or part of the same processing platform.

FIG. 2A shows an example of a software development lifecycle in an illustrative embodiment. A software development lifecycle is comprised of a number of stages 210 through 250. In the example of FIG. 2A, a software development stage 210 comprises generating (e.g., writing) the software code for a given application. A software testing stage 220 tests the application software code. A software release stage 230 comprises delivering the application software code to a repository. A software deployment stage 240 comprises deploying the application software code to a production environment. Finally, a validation and compliance stage 250 comprises the steps to validate a deployment, for example, based at least in part on the needs of a given organization. For example, image security scanning tools may be employed to ensure a quality of the deployed images by comparing them to known vulnerabilities, such as those known vulnerabilities in a catalog of common vulnerabilities and exposures (CVEs).

FIG. 2B shows an example of one or more pipeline jobs in various pipeline stages 270-A through 270-N (collectively, pipeline stages 270) of a software deployment pipeline 260 in an illustrative embodiment. The pipeline stages 270-A through 270-N of a software deployment pipeline 260 may correspond, for example, to the stages 210, 220, 230, 240 and 250 of the software development lifecycle of FIG. 2A.

In the example of FIG. 2B, each pipeline stage 270 is comprised of a plurality of pipeline jobs, such as pipeline jobs A.1 and A.2 for pipeline stage 270-A. Each pipeline job is comprised of one or more steps (e.g., tasks, scripts and/or a reference to an external template), such as steps A.1.1 and A.1.2 of pipeline job A.1 and steps A.2.1 and A.2.2 of pipeline job A.2.

In one or more embodiments, a pipeline can comprise one or more of the following elements: (i) local development environments (e.g., the computers of individual developers); (ii) a CI server (or a development server); (iii) one or more test servers (e.g., for functional user interface testing of the product); and (iv) a production environment. The pipelines may be defined, for example, in YAML (Yet Another Markup Language) with a set of commands executed in series to perform the necessary activities (e.g., the steps of each pipeline job).

FIG. 3 illustrates a software deployment pipeline generator 300 (e.g., a part of an IDE) configured for software deployment pipeline generation using generative AI, in accordance with an illustrative embodiment. As shown in FIG. 3, the software deployment pipeline generator 300 interacts with one or more DevOps collaboration tools 305, in a manner described herein. The DevOps collaboration tools 305 may be implemented at least in part, for example, as one or more of the Git-based DevOps and/or CI/CD tools referenced above in conjunction with the software development system 105 of FIG. 1.

In addition, a user employing a user device 370 utilizes a graphical user interface 400, discussed further below in conjunction with FIG. 4, provided by the software deployment pipeline generator 300 to interact with one or more visual representations of software deployment pipeline resources provided by a CI/CD pipeline engine 340. Generally, the graphical user interface 400 provides access to a software deployment pipeline editor, a configuration file editor, one or more editor extensions and a reusable CI/CD resource library, as discussed further below.

Upon connecting to one or more of the DevOps collaboration tools 305 for a given project, for example, in response to a selection from the user device 370 of the given project, a DevOps metadata processor 310 accesses the canonical schemas and other aspects of the repository composition available from the DevOps collaboration tools 305 for the given project using an application programming interface (API) 315 (e.g., provided by the respective DevOps collaboration tool 305). In the example of FIG. 3, the DevOps metadata processor 310 obtains templates 320, pipelines 325 and blueprints 330.

The CI/CD pipeline engine 340 interacts with the DevOps metadata processor 310 to translate at least some of the templates 320, pipelines 325 and blueprints 330, and potentially additional reusable resources, obtained at least partially from the one or more DevOps collaboration tools 305. In some embodiments, the CI/CD pipeline engine 340 translates the obtained reusable resources into a renderable format, for presentation to the user device 370 using the graphical user interface 400.

As shown in FIG. 3, the exemplary CI/CD pipeline engine 340 comprises an include parser 350. The include parser 350 processes files referenced in include statements in a YAML file (e.g., whereby a first YAML file calls a second YAML file). When a user requests to commit a given software deployment pipeline, a configuration file editor 380 will evaluate the software deployment pipeline for compliance with best practices and other policies. In addition, the configuration file editor 380 may recommend missing pipeline stages and/or missing pipeline jobs of a given pipeline stage, for example, based on predictions of a generative AI model 395. In particular an editor completion API of the configuration file editor 380 may provide a system prompt to an inference API 390 of an orchestration engine (e.g., for tokenization). The inference API 390 provides the tokenized system prompt to the generative AI model 395 which will provide a prediction of at least a portion of a software development pipeline as a response, as discussed further below, for example, in conjunction with FIGS. 6 and 7.

As noted above, the orchestration engine may be implemented, at least in part, using the functionality of Kubernetes or variants thereof.

FIG. 4 illustrates the graphical user interface 400 of FIG. 3 in further detail, in accordance with an illustrative embodiment. In the example of FIG. 4, the graphical user interface 400 comprises an icon 410 to access a software deployment pipeline editor, an icon 420 to access a configuration file editor, an icon 430 to access editor extensions and an icon 440 to access a reusable CI/CD resource library.

In some embodiments, the configuration file editor enables an editing of configuration files (e.g., YAML files) and a portion of the configuration file editor may include a validation window that validates a software development pipeline. The editor extensions allow Visual Studio (VS) Code to be used to extend the functionality of the software deployment pipeline generator 300 of FIG. 3, the configuration file editor 380 and/or an IDE, for example.

In some embodiments, the graphical user interface 400 of FIG. 4 may be organized using tabs or another visual organization method to provide access to pipeline jobs, DevOps blueprints and images of virtual resources. A jobs tab, for example, may display representations of available pipeline jobs from the latest DevOps blueprints, optionally with multiple filters to search for pipeline jobs. Upon selecting a job tile for a particular pipeline job, for example, users can view the metadata associated with the corresponding pipeline job, such as a job description, supported languages, contributors, template data and scripts, and optionally launch an execution of the particular pipeline job for purposes of testing and debugging.

A DevOps blueprint tab may display a list of available DevOps blueprints. By selecting a job tile for a particular DevOps blueprint, for example, users can view the pipeline stages of the particular DevOps blueprint and the corresponding pipeline jobs for each pipeline stage, for example, when the user wants to add pipeline jobs from a particular DevOps blueprint into the software deployment pipeline.

A DevOps images tab, for example, may present a catalogue of available DevOps docker images and provide for user discovery of DevOps images using software name and version information.

FIG. 5 shows an example of at least portions of the software development lifecycle of FIG. 2A in further detail in an illustrative embodiment. In the FIG. 5 example, a main branch 502 corresponds to software code of at least one software application. A release branch 504 is created based on the main branch 502. For example, the release branch 504 may be created based on development release timelines corresponding to the software application.

One or more developers (e.g., corresponding to user devices 102) create respective personal branches based on the release branch 504, and perform development work using a sandbox environment 506 and a code IDE (integration development environment) 508. Many developers prefer to write software code using such an IDE that allows the software to be developed in any programming language without having to deal with a particular language syntax. Developers may have multiple IDEs available for application development but there is currently no IDE available for writing software deployment pipeline code.

Developers can commit the changes made in their personal branches to the release branch 504. In the FIG. 5 example, a non-production deployment pipeline 512 is triggered according to one or more specified schedules. The non-production deployment pipeline 512 deploys any changes resulting from the change requests to one or more non-production environments 514.

In some examples, the non-production environment(s) 514 may include one or more of: a developer integration testing (DIT) environment, a system integration testing (SIT) environment, and a global environment. As noted above, the non-production deployment pipeline 512 may be triggered according to schedules defined for each of the non-production environments 514 (e.g., a first schedule for a DIT environment and a second schedule for an SIT environment).

A production deployment pipeline 518 can be triggered when the release branch 504 of the application is ready to be deployed to a production environment 522. Generally, the production deployment pipeline 518 collects any changes that were made to the release branch 504, creates a deployment package, and deploys the package to the production environment 522.

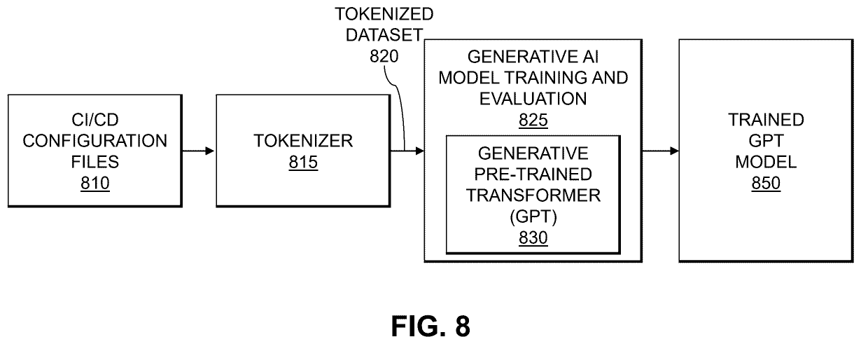

FIG. 6 illustrates a generation of at least a portion of a software deployment pipeline using a generative AI model in an illustrative embodiment. In the example of FIG. 6, a software deployment pipeline editor 605 is employed, for example, by a user to edit a CI/CD configuration file 610. The CI/CD configuration file 610 is applied to a generative AI prompt generator 615 that generates a generative AI prompt 620 for a generative AI model 625, as discussed further below in conjunction with FIGS. 8 through 10. The CI/CD configuration file 610 is shown in FIG. 6 with a dashed outline to indicate that the CI/CD configuration file 610 may not be present in some embodiments (e.g., where the CI/CD configuration file 610 has not yet been generated and the generative AI model 625 predicts one or mor pipeline jobs, for example, based on a selected software development project). Generally, the generative AI model 625 receives the generative AI prompt 620 (e.g., as a system prompt) and generates a predicted pipeline portion 630 as a response, as discussed further below in conjunction with FIG. 7. In at least some embodiments, the generative AI model 625 converts the received generative AI prompt 620 into vectors to predict one or more next words and/or one or more recommend pipeline jobs.

In at least one embodiment, the generative AI prompt 620 may be based, at least in part, on a cursor position of a user within the CI/CD configuration file 610 (for example, a predefined number of rows (or characters) before and/or after a cursor position), and the corresponding predicted pipeline portion 630 may comprise an automatic code completion prediction. In a further variation, a user may not have begun affirmatively editing a CI/CD configuration file 610 and the only information available may comprise a selected software development project (which may be inferred in some embodiments based on one or more other files associated with a given software development project that are currently open). Thus, the selected software development project may be provided to the generative AI model 625 as a system prompt (e.g., a generative AI prompt 620) and the corresponding predicted pipeline portion 630 may comprise one or more predicted pipeline jobs, based on the selected software development project.

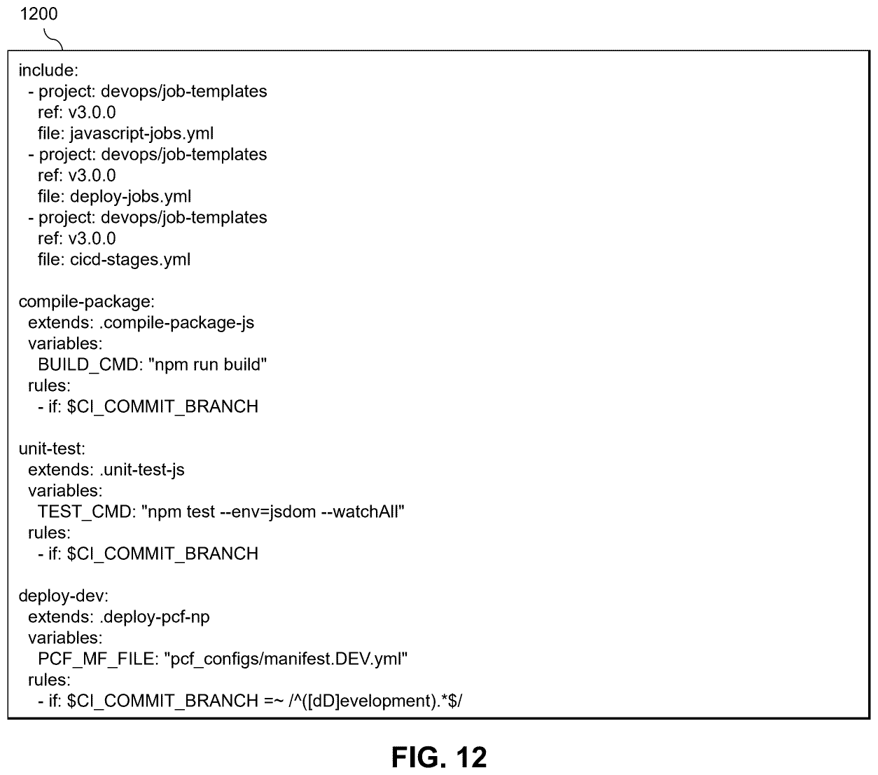

The predicted pipeline portion 630 is provided in a feedback manner to the software deployment pipeline editor 605 that may optionally show the predicted pipeline portion 630, in context, in the CI/CD configuration file 610 for approval by a user. For example, the predicted pipeline portion 630 may comprise a prediction that the compile package job needs to extend “. compile-package-js,” based on the presence of an include file “javascript-jobs.yml” in the CI/CD configuration file 610, as discussed further below in conjunction with FIG. 12, and the prediction comprises a corresponding code snippet. Likewise, the generative AI model 625 may recognize a missing code element, such as a verify-build job and provide “sast-checkmarx” as a suggestion, even though the user has not completed typing the full job name. In addition, the generative AI model 625 may provide automated code completion suggestions (for example, predicted next words) based on user prompts. For example, if a user types “#add: compile package job,” the generative AI model 625 may suggest the appropriate code.

The generative AI model 625 may enable creation of a CI/CD pipeline with minimal user intervention whenever a development project is loaded in an IDE. The project compositions (e.g., the project details, technology stack and deployment methodology) may be obtained and a CI/CD pipeline (or one or more jobs associated therewith) may be automatically provided by the generative AI model 625.

The generative AI model 625 may also perform pipeline validation and generate errors and provide warnings, for example, directly integrated into an IDE and/or the configuration file editor. In this manner, missing variable assignments, a use of deprecated docker images and/or missing security jobs in the pipeline may be identified. In this manner, a developer may select and add one or more pipeline jobs to a CI/CD pipeline from a variety of jobs recommended by the generative AI model 625.

FIG. 7 is a flow diagram illustrating an exemplary implementation of a process for generating at least a portion of a software deployment pipeline using generative AI in an illustrative embodiment. In the example of FIG. 7, a user logs in to a software deployment pipeline editor in step 702 and navigates to a pipeline page. In step 704, the user may open a CI/CD configuration file in the software deployment pipeline editor (e.g., the software deployment pipeline editor 605 of FIG. 6).

One or more system prompts (e.g., the generative AI prompt 620 of FIG. 6) may be generated in step 706 based on a cursor position in the software deployment pipeline editor, for example, and a user activation of the generative AI model (e.g., the generative AI model 625 of FIG. 6). In other embodiments, the generation and application of the one or more system prompts to the generative AI model may be performed automatically, without a user activation.

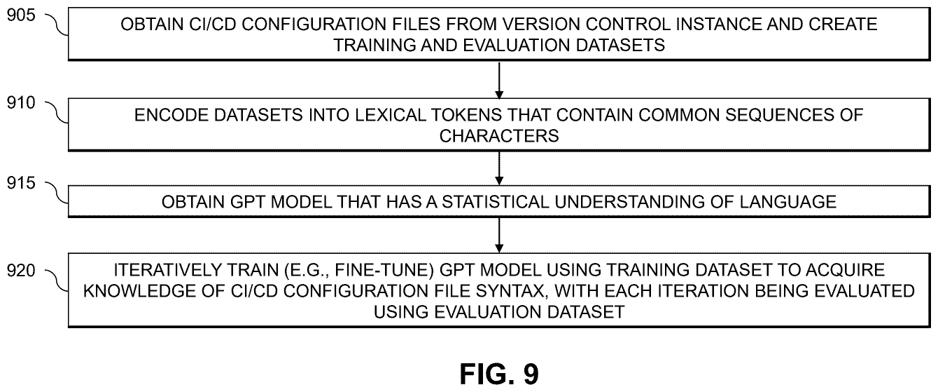

In step 708, the one or more system prompts are sent to an inference API (e.g., inference API 390 of FIG. 3) of the orchestration engine (e.g., orchestration engine 130 of FIG. 1) for tokenization. The one or more system prompts are applied in step 710 to a trained generative AI model for prediction, as discussed further below in conjunction with FIGS. 8 and 9, for example. The trained generative AI model provides a prediction (e.g., a code completion or one or more recommended pipeline jobs) in step 712 as a response from the inference API. The predicted response may be provided in step 714 to a user as a pipeline insertion suggestion, for example.

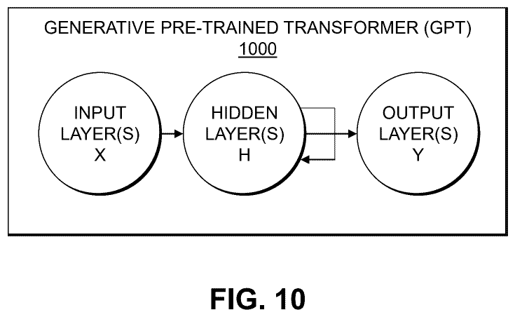

FIG. 8 illustrates a training and evaluation of a generative AI model in an illustrative embodiment. In the example of FIG. 8, during a training and evaluation phase a plurality of CI/CD configuration files 810 are applied to a tokenizer 815 that tokenizes the CI/CD configuration files 810 to generate a tokenized dataset 820 for training and evaluating one or more generative AI models at stage 825, as discussed further below in conjunction with FIG. 9. The training and evaluating of generative AI models at stage 825 leverages a generative pre-trained transformer (GPT) 830 that is fine-tuned during the training process using training data (e.g., a portion of the tokenized dataset 820) to generate a trained GPT model 850 or another trained generative AI model, having the acquired knowledge of syntax associated with the CI/CD configuration files 810 used for training. Multiple training iterations may be performed, with each iteration being evaluated using an evaluation dataset (e.g., a portion of the tokenized dataset 820). A representative GPT 830 is discussed further below in conjunction with FIG. 10.

It is noted that the same training and evaluation techniques described in conjunction with FIG. 8 may be employed to support the various predicted pipeline portions (e.g., predicted pipeline portions 630) described herein, such as code completion, recommended pipeline jobs and correction of syntax and/or structure of a CI/CD configuration file.

FIG. 9 is a flow diagram illustrating an exemplary implementation of a process for training and evaluating a generative AI model, in an illustrative embodiment. In the example of FIG. 9, multiple CI/CD configuration files are obtained in 905 (e.g., from a version control instance) and training and evaluation datasets are created. The CI/CD configuration files obtained in 905 may be limited to existing CI/CD configuration files (e.g., YAML files) from the version control instance of a given company or organization.

The datasets are encoded in step 910 into lexical tokens that contain common sequences of characters (e.g., the most commonly occurring sequences of characters) from the dataset. The encoding into lexical tokens in step 910 may be performed using the tokenizer 815 of FIG. 8, for example.

A GPT model (e.g., a large language model) is obtained in step 915 that has a statistical understanding of language. A pretrained model may be used to avoid the costs associated with energy, resources, and time when creating a model from scratch. The GPT model may be fine-tuned in step 920 (e.g., using transfer learning) by iteratively training the GPT model using the training dataset to acquire knowledge of the CI/CD configuration file syntax, with each iteration being evaluated using an evaluation dataset. Each iteration in the training loop may be evaluated to guide the model towards improved accuracy. Once the trained (e.g., fine-tuned) model reaches a sufficient accuracy, the trained model has acquired the knowledge of CI/CD configuration file syntax.

FIG. 10 illustrates a generative pre-trained transformer 1000 (e.g., a GPT) in an illustrative embodiment. The GPT 1000 may be a deep learning language model that is pre-trained on large text corpus and can be fine-tuned using the disclosed generative AI-based pipeline generation techniques to learn a syntax of CI/CD configuration files. In the example of FIG. 10, the GPT 1000 comprises an input layer, X, a set of hidden layers, H, and an output layer, Y, in a known manner. It is noted that in some embodiments, multiple GPTs 1000 may be employed in parallel.

In at least some embodiments, the input layers, X, provide initial data for the GPT 1000, based on the tokenized dataset. The hidden layers, H, between the one or more input layers, X, and the one or more output layers, Y, may process the input information and make connections among the applied tokenized dataset to make predictions. Each neuron in the hidden layer(s) evaluates the tokenized information from the input layer, X, and iteratively finds patterns used for the predictions, using weights to indicate an importance of the inputs and applying them to an activation function or another decision-making process. The output layers, Y, may determine a final prediction by combining information from the hidden layers.

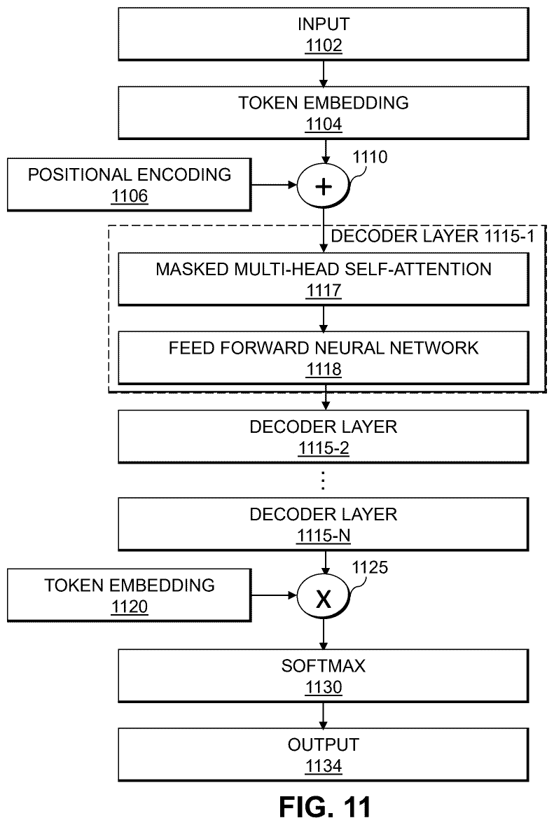

FIG. 11 is a flow chart illustrating a process for software deployment pipeline generation using generative AI in an illustrative embodiment. In the example of FIG. 11, an input is obtained in step 1102 (e.g., in the form of words or portions of words). A token embedding is performed in step 1104 whereby an embedding layer maps the input tokens (e.g., words or sub-words) to continuous vector representations, which can be processed by transformer blocks. A positional encoding is performed in step 1106 to add positional encoding information to the input embeddings to provide information about the relative position of the tokens. The token embeddings and the positional encodings are aggregated in step 1110.

The tokenized input is then passed to multiple decoder layers 1115-1 through 1115-N of the generative AI model to generate a next sequence of words, provided as a response. Each of the decoder layers 1115 can be considered a transformer block and comprises a masked multi-head self-attention layer 1117 and a feed forward neural network layer 1118. The aggregated token embeddings and positional encodings are passed to the masked multi-head self-attention layer 1117 where the inputs are separated into key, query and value pairs that are linearly projected using a MLP (multilayer perceptron) layer. Key and query values are multiplied and scaled to generate attention scores that are then multiplied with the value and linearly projected to generate an output. The feed forward neural network layer 1118 receives the normalized output from the masked multi-head self-attention layer 1117 and performs a linear projection over the inputs to form a larger hidden representation and projection back to the original dimensions.

As shown in FIG. 11, the output of the final decoder layer 1115-N is multiplied with the token embeddings 1120 (e.g., obtained in step 1104) in step 1125 and the result is applied to a softmax function in step 1130 for classification tasks. The softmax function generates a probability distribution over a set of output classes. The output of the final layer 1115-N is thus converted before being normalized with the softmax function. The normalized values obtained from the model can be interpreted as the likelihood or probability that a particular input belongs to one or more output classes. The query, key, and value vectors for each token in the input sequence are frequently calculated using linear functions in the attention mechanism. The output of the softmax function is provided as an output in step 1134.

FIG. 12 illustrates a CI/CD configuration file 1200 (e.g., a YAML file) in an illustrative embodiment. In the example of FIG. 12, the representative CI/CD configuration file 1200 comprises a first section that includes various resources associated with a “devops/job-templates” project, such as YAML (.yml) configuration files “javascript-jobs.yml”, “deploy-jobs.yml” and “cicd-stages.yml.” A second section extends a compile package job with a Javascript file, “. compile-package-js”. A third section extends a unit test job with a Javascript file, “.unit-test-js”. A final section extends a deploy-devjob with a Javascript file, “.deploy-pcf-np”.

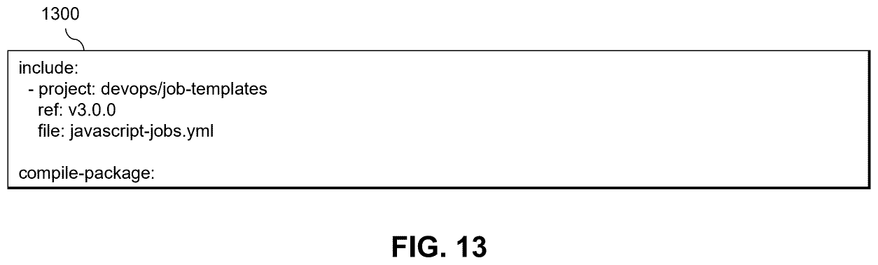

FIG. 13 illustrates a system prompt 1300 for a generative AI model in an illustrative embodiment. In the example of FIG. 13, the representative system prompt 1300 comprises a portion of a CI/CD configuration file, such as a portion of the CI/CD configuration file 1200. The system prompt 1300 corresponds to an incomplete extension of a compile package job. The system prompt 1300 will be applied to a generative AI model, as described herein, which will provide a predicted portion of a pipeline, such as an autocompletion of the incomplete extension of the compile package job shown in FIG. 13.

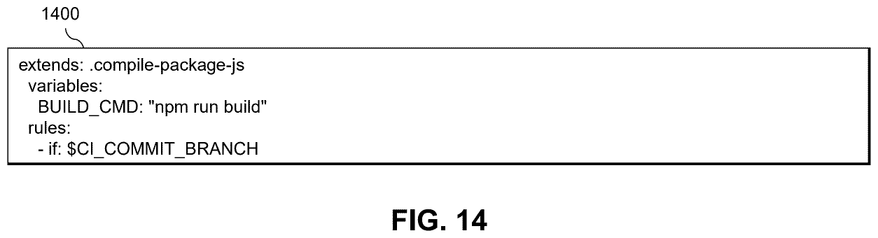

FIG. 14 illustrates a predicted portion 1400 of a pipeline provided by a generative AI model in an illustrative embodiment. In the example of FIG. 14, which extends the example of FIG. 13, the generative AI model provides the predicted portion 1400 in response to the system prompt 1300. The predicted portion 1400 may comprise a prediction that the compile package job needs to extend “.compile-package-js,” based on the presence of an include file “javascript-jobs.yml” in the portion of the CI/CD configuration file included in the system prompt 1300, and the predicted portion 1400 comprises a corresponding code snippet with the prediction that the compile package job extends “.compile-package-js”.

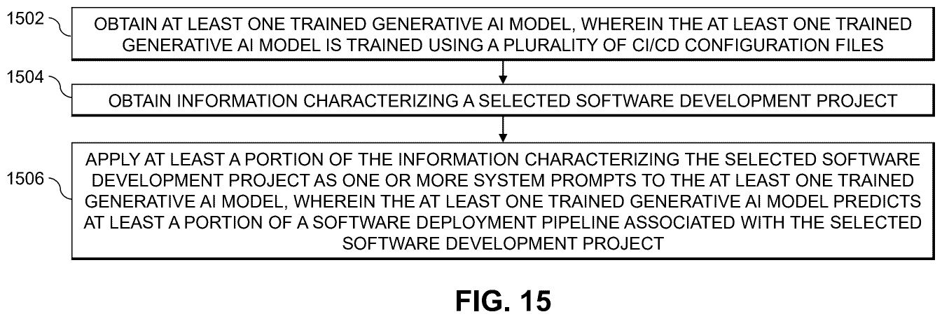

FIG. 15 is a flow chart illustrating a process for software deployment pipeline generation using generative AI, in accordance with an illustrative embodiment. In the example of FIG. 15, at least one trained generative AI model is obtained in step 1502, where the at least one trained generative AI model is trained using a plurality of CI/CD configuration files.

Information characterizing a selected software development project is obtained in step 1504. At least a portion of the information characterizing the selected software development project is applied as one or more system prompts in step 1506 to the at least one trained generative AI model, where the at least one trained generative AI model predicts at least a portion of a software deployment pipeline associated with the selected software development project.

In one or more embodiments, the plurality of CI/CD configuration files are associated with an organization associated with the selected software development project. A training of the at least one trained generative AI model may update at least one pre-trained generative AI model to learn a syntax associated with the plurality of CI/CD configuration files.

In some embodiments, the predicted portion of the software deployment pipeline associated with the selected software development project comprises one or more pipeline jobs in one or more pipeline stages in the software deployment pipeline associated with the selected software development project. The graphical user interface of an integrated development environment may present a plurality of software development projects to at least one user, and in response to the at least one user selecting the selected software development project from the plurality of software development projects, the at least one trained generative AI model may predict the one or more pipeline jobs in the one or more pipeline stages in the software deployment pipeline.

In at least one embodiment, the predicted portion of the software deployment pipeline associated with the selected software development project is presented to the at least one user in a software deployment pipeline editor for approval prior to adding the predicted portion to the software deployment pipeline. The predicted portion of the software deployment pipeline associated with the selected software development project may comprise one or more corrections of one or more of a syntax and a structure of at least one CI/CD configuration file being edited by at least one user.

In an embodiment. information characterizing a cursor position in at least one CI/CD configuration file being edited by at least one user is obtained, and at least one portion, selected based at least in part on the cursor position, of text from the at least one CI/CD configuration file may be applied as a one or more system prompts to the at least one trained generative AI model, wherein the at least one trained generative AI model provides suggested software code as an automatic completion of the at least one portion of text from the at least one CI/CD configuration file.

The particular processing operations and other network functionality described in conjunction with FIGS. 2A, 5, 6 through 9, 11 and 15, for example, are presented by way of illustrative example only, and should not be construed as limiting the scope of the disclosure in any way. Alternative embodiments can use other types of processing operations to provide functionality for pipeline generation using generative AI. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

It should also be understood that the disclosed techniques for software deployment pipeline generation using generative AI can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

Among other benefits, the disclosed techniques for software deployment pipeline generation using generative AI enables a creation of a CI/CD pipeline with minimal user intervention whenever a development project is loaded in an IDE. The project details, technology stack and deployment methodology may be obtained and a CI/CD pipeline may be automatically provided by the generative AI model. In addition, automatic code completions may be provided completions by analyzing the project code, existing pipeline code, target runtime environments and previous pipeline execution logs as context and providing code suggestions to users at one or more steps of a CI/CD pipeline creation.

In some embodiments, the disclosed techniques for software deployment pipeline generation using generative AI integrates CI/CD capabilities into an IDE, thereby empowering developers to generate CI/CD pipelines without the need for additional tools. In this manner, the following features may be included in the CI/CD development workflow: pipeline construction (e.g., generating CI/CD pipelines within the familiar environment of an IDE); pipeline validation (e.g., validating and ensuring the integrity of CI/CD pipelines directly from the IDE, minimizing errors and optimizing deployment processes); interactive pipeline debugging (e.g., debugging CI/CD pipelines interactively, identifying and resolving issues efficiently without leaving the IDE); DevOps tool integration (e.g., integrating with a variety of DevOps tools, consolidating development and deployment ecosystems within the IDE); and script updates (e.g., update and manage scripts directly within the IDE, ensuring adaptation to evolving project requirements).

The disclosed techniques for pipeline generation using generative AI may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based generative AI-based pipeline generation engine, or portions thereof, are illustratively implemented for use by tenants of such a multi-tenant environment.

Cloud infrastructure as disclosed herein can include cloud-based systems. Virtual machines provided in such systems can be used to implement at least portions of a generative AI-based pipeline generation platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

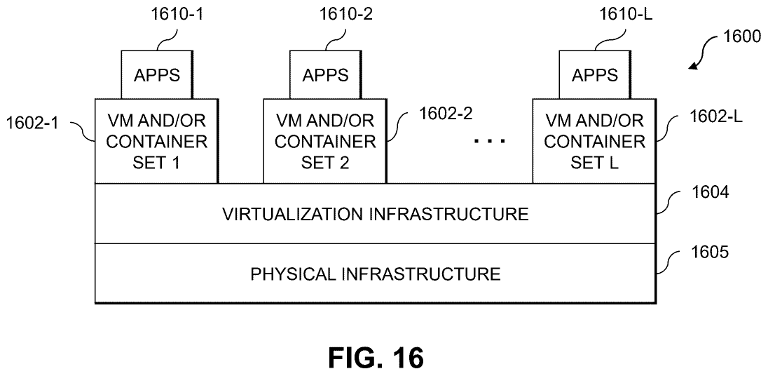

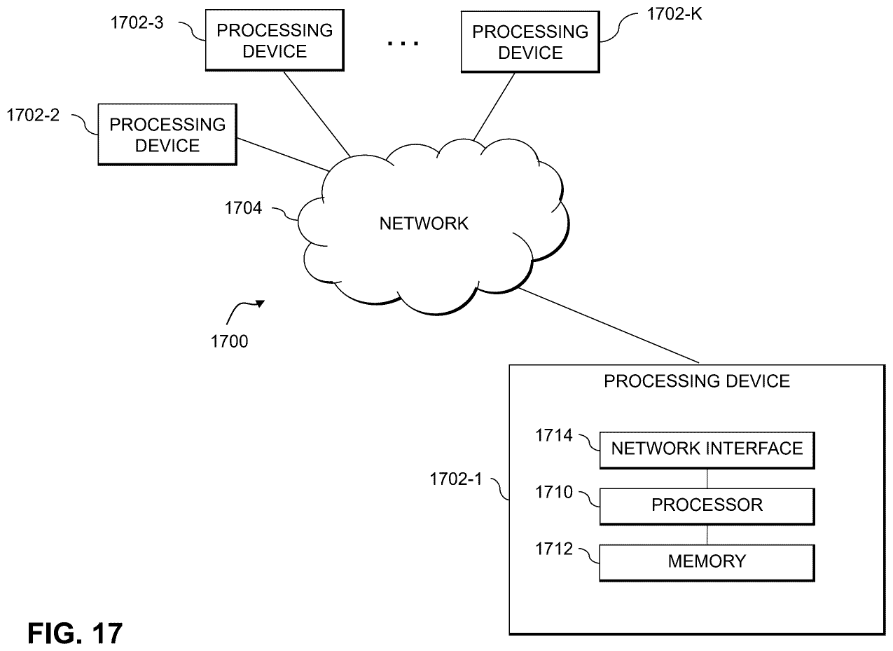

Illustrative embodiments of processing platforms will now be described in greater detail with reference to FIGS. 16 and 17. These platforms may also be used to implement at least portions of other information processing systems in other embodiments.

FIG. 16 shows an example processing platform comprising cloud infrastructure 1600. The cloud infrastructure 1600 comprises a combination of physical and virtual processing resources that may be utilized to implement at least a portion of the information processing system 100. The cloud infrastructure 1600 comprises multiple VMs and/or container sets 1602-1, 1602-2, . . . 1602-L implemented using virtualization infrastructure 1604. The virtualization infrastructure 1604 runs on physical infrastructure 1605, and illustratively comprises one or more hypervisors and/or operating system level virtualization infrastructure. The operating system level virtualization infrastructure illustratively comprises kernel control groups of a Linux operating system or other type of operating system.

The cloud infrastructure 1600 further comprises sets of applications 1610-1, 1610-2, . . . 1610-L running on respective ones of the VMs/container sets 1602-1, 1602-2, . . . 1602-L under the control of the virtualization infrastructure 1604. The VMs/container sets 1602 may comprise respective VMs, respective sets of one or more containers, or respective sets of one or more containers running in VMs.

In some implementations of the FIG. 16 embodiment, the VMs/container sets 1602 comprise respective VMs implemented using virtualization infrastructure 1604 that comprises at least one hypervisor. Such implementations can provide generative AI-based pipeline generation functionality of the type described above for one or more processes running on a given one of the VMs. For example, each of the VMs can implement generative AI-based pipeline generation control logic and associated software deployment pipeline recommendation functionality for one or more processes running on that particular VM. The underlying physical machines may comprise one or more distributed processing platforms that include one or more storage systems.

In other implementations of the FIG. 16 embodiment, the VMs/container sets 1602 comprise respective containers implemented using virtualization infrastructure 1604 that provides operating system level virtualization functionality, such as support for Docker containers running on bare metal hosts, or Docker containers running on VMs. The containers are illustratively implemented using respective kernel control groups of the operating system. Such implementations can provide generative AI-based pipeline generation functionality of the type described above for one or more processes running on different ones of the containers. For example, a container host device supporting multiple containers of one or more container sets can implement one or more instances of generative AI-based pipeline generation control logic and associated software deployment pipeline recommendation functionality.

As is apparent from the above, one or more of the processing modules or other components of system 160 may each run on a computer, server, storage device or other processing platform element. A given such element may be viewed as an example of what is more generally referred to herein as a “processing device.” The cloud infrastructure 1600 shown in FIG. 16 may represent at least a portion of one processing platform. Another example of such a processing platform is processing platform 1700 shown in FIG. 17.

The processing platform 1700 in this embodiment comprises at least a portion of the given system and includes a plurality of processing devices, denoted 1702-1, 1702-2, 1702-3, . . . 1702-K, which communicate with one another over a network 1704. The network 1704 may comprise any type of network, such as a WAN, a LAN, a satellite network, a telephone or cable network, a cellular network, a wireless network such as WiFi or WiMAX, or various portions or combinations of these and other types of networks.

The processing device 1702-1 in the processing platform 1700 comprises a processor 1710 coupled to a memory 1712. The processor 1710 may comprise a microprocessor, a microcontroller, an ASIC, an FPGA or other type of processing circuitry, as well as portions or combinations of such circuitry elements, and the memory 1712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1702-1 is network interface circuitry 1714, which is used to interface the processing device with the network 1704 and other system components, and may comprise conventional transceivers.

The other processing devices 1702 of the processing platform 1700 are assumed to be configured in a manner similar to that shown for processing device 1702-1 in the figure.

Again, the particular processing platform 1700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 16 or 17, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining at least one trained generative artificial intelligence (AI) model, wherein the at least one trained generative AI model is trained using a plurality of CI/CD configuration files;
obtaining information characterizing a selected software development project; and
applying at least a portion of the information characterizing the selected software development project as one or more system prompts to the at least one trained generative AI model, wherein the at least one trained generative AI model predicts at least a portion of a software deployment pipeline associated with the selected software development project;
wherein the method is performed by at least one processing device comprising a processor coupled to a memory.

2. The method of claim 1, wherein the plurality of CI/CD configuration files are associated with an organization associated with the selected software development project.

3. The method of claim 1, wherein a training of the at least one trained generative AI model updates at least one pre-trained generative AI model to learn a syntax associated with the plurality of CI/CD configuration files.

4. The method of claim 1, wherein the predicted portion of the software deployment pipeline associated with the selected software development project comprises one or more pipeline jobs in one or more pipeline stages in the software deployment pipeline associated with the selected software development project.

5. The method of claim 4, wherein a graphical user interface of an integrated development environment presents a plurality of software development projects to at least one user, and in response to the at least one user selecting the selected software development project from the plurality of software development projects, the at least one trained generative AI model predicts the one or more pipeline jobs in the one or more pipeline stages in the software deployment pipeline.

6. The method of claim 1, wherein the predicted portion of the software deployment pipeline associated with the selected software development project is presented to at least one user in a software deployment pipeline editor for approval prior to adding the predicted portion to the software deployment pipeline.

7. The method of claim 1, further comprising obtaining information characterizing a cursor position in at least one CI/CD configuration file being edited by at least one user and applying at least one portion, selected based at least in part on the cursor position, of text from the at least one CI/CD configuration file as one or more system prompts to the at least one trained generative AI model, wherein the at least one trained generative AI model provides suggested software code as an automatic completion of the at least one portion of text from the at least one CI/CD configuration file.

8. The method of claim 1, wherein the predicted portion of the software deployment pipeline associated with the selected software development project comprises one or more corrections of one or more of a syntax and a structure of at least one CI/CD configuration file being edited by at least one user.

9. An apparatus comprising:
at least one processing device comprising a processor coupled to a memory;
the at least one processing device being configured to implement the following steps:
obtaining at least one trained generative artificial intelligence (AI) model, wherein the at least one trained generative AI model is trained using a plurality of CI/CD configuration files;
obtaining information characterizing a selected software development project; and
applying at least a portion of the information characterizing the selected software development project as one or more system prompts to the at least one trained generative AI model, wherein the at least one trained generative AI model predicts at least a portion of a software deployment pipeline associated with the selected software development project.

10. The apparatus of claim 9, wherein the plurality of CI/CD configuration files are associated with an organization associated with the selected software development project.

11. The apparatus of claim 9, wherein a training of the at least one trained generative AI model updates at least one pre-trained generative AI model to learn a syntax associated with the plurality of CI/CD configuration files.

12. The apparatus of claim 9, wherein the predicted portion of the software deployment pipeline associated with the selected software development project comprises one or more pipeline jobs in one or more pipeline stages in the software deployment pipeline associated with the selected software development project, wherein a graphical user interface of an integrated development environment presents a plurality of software development projects to at least one user, and in response to the at least one user selecting the selected software development project from the plurality of software development projects, the at least one trained generative AI model predicts the one or more pipeline jobs in the one or more pipeline stages in the software deployment pipeline.

13. The apparatus of claim 9, further comprising obtaining information characterizing a cursor position in at least one CI/CD configuration file being edited by at least one user and applying at least one portion, selected based at least in part on the cursor position, of text from the at least one CI/CD configuration file as one or more system prompts to the at least one trained generative AI model, wherein the at least one trained generative AI model provides suggested software code as an automatic completion of the at least one portion of text from the at least one CI/CD configuration file.

14. The apparatus of claim 9, wherein the predicted portion of the software deployment pipeline associated with the selected software development project comprises one or more corrections of one or more of a syntax and a structure of at least one CI/CD configuration file being edited by at least one user.

15. A non-transitory processor-readable storage medium having stored therein program code of one or more software programs, wherein the program code when executed by at least one processing device causes the at least one processing device to perform the following steps:
obtaining at least one trained generative artificial intelligence (AI) model, wherein the at least one trained generative AI model is trained using a plurality of CI/CD configuration files;
obtaining information characterizing a selected software development project; and
applying at least a portion of the information characterizing the selected software development project as one or more system prompts to the at least one trained generative AI model, wherein the at least one trained generative AI model predicts at least a portion of a software deployment pipeline associated with the selected software development project.

16. The non-transitory processor-readable storage medium of claim 15, wherein the plurality of CI/CD configuration files are associated with an organization associated with the selected software development project.

17. The non-transitory processor-readable storage medium of claim 15, wherein a training of the at least one trained generative AI model updates at least one pre-trained generative AI model to learn a syntax associated with the plurality of CI/CD configuration files.

18. The non-transitory processor-readable storage medium of claim 15, wherein the predicted portion of the software deployment pipeline associated with the selected software development project comprises one or more pipeline jobs in one or more pipeline stages in the software deployment pipeline associated with the selected software development project, wherein a graphical user interface of an integrated development environment presents a plurality of software development projects to at least one user, and in response to the at least one user selecting the selected software development project from the plurality of software development projects, the at least one trained generative AI model predicts the one or more pipeline jobs in the one or more pipeline stages in the software deployment pipeline.

19. The non-transitory processor-readable storage medium of claim 15, further comprising obtaining information characterizing a cursor position in at least one CI/CD configuration file being edited by at least one user and applying at least one portion, selected based at least in part on the cursor position, of text from the at least one CI/CD configuration file as one or more system prompts to the at least one trained generative AI model, wherein the at least one trained generative AI model provides suggested software code as an automatic completion of the at least one portion of text from the at least one CI/CD configuration file.

20. The non-transitory processor-readable storage medium of claim 15, wherein the predicted portion of the software deployment pipeline associated with the selected software development project comprises one or more corrections of one or more of a syntax and a structure of at least one CI/CD configuration file being edited by at least one user.
